(19) United States
(12) Patent Application Publication
(10) Pub. No.: US 2017/0116260 A1
(43) Pub. Date: Apr. 27, 2017

(54) Using a dimensional data model for transforming a natural language query to a structured language query

(71) Applicant: Google Inc., Mountain View, CA (US)

(72) Inventor: Biswapesh Chattopadhyay, San Jose, CA (US)

(73) Assignee: Google Inc., Mountain View, CA (US)

(21) Appl. No.: 14/189,003

(22) Filed: Feb. 25, 2014

(51) Int. Cl. G06F 17/30

(52) U.S. Cl. CPC G06F 17/30401

(57) ABSTRACT

A natural language query (NLQ), written in a language native to a user can be transformed to a structured language query (SLQ) that is supported by a relational database interface in a manner that accurately maps relevant elements and supports complex filters, joins, aggregations, or other operations. Search engine technology can be leveraged to convert the NLQ to an intermediate semantic query. A dimensional model over the relational database can be leveraged to convert the semantic query to the SLQ. A single NLQ might map to many possible SLQs, in which case a ranking algorithm for ranking terms as well as tables in the database can select the most likely SLQ, which can be presented to the user.

### TECHNICAL FIELD

This disclosure generally relates to employing a dimensional data model over a relational database for transforming a natural language query that users might construct with very little sophistication to a structured language query suitable for accessing desired data in the relational database.

### BACKGROUND

Non-technical and/or casual users of database interfaces often have cause to lookup information in relational databases, which in many cases can be quite large or complex. For example, a sales employee might want to learn more about which of his products or an associated feature are trending with a particular demographic or the like. However, non-technical and/or casual users are often unable to formulate a proper query, and commonly do not have the time to learn enough details about large-scale databases to formulate a query that is syntactically correct, semantically correct, and/or efficient to get the desired data from the database. As the data size and complexity (e.g., number of tables, columns or other portions of the database) grows, this issue becomes super-linearly more problematic

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Systems disclosed herein relate to transforming a natural language query to a structured language query. An interface component can be configured to interface to a backend query system that includes data organized as a relational database that is accessed according to a defined structured language and an index of the relational database. A receiving component can be configured to receive natural language query data representing a first query with a set of terms constructed according to a natural language. A rewriter component can be configured to parse the first query and classify a term of the set of terms as an object of a set of objects included in the index based on a comparison of the term to the objects of the set of objects. The rewriter component can rewrite the first query as a second query that includes the object and is based on a confidence score for a match between the term and the object. This second query can represent an intermediate semantic query. An aggregation component can be configured to identify a portion of the relational database to reference in connection with the second query based on an aggregation of object matches included in the portion. A query component can be configured to transform the second query to a structured language query in accordance with a defined structured language based on the portion.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a block diagram of an example system that can provide for translating a natural language query (NLQ) to a structured language query (SLQ) suitable for use with a relational database in accordance with certain embodiments of this disclosure;

FIG. 2 provides a block diagram illustration that depicts numerous examples relating to types or classifications of the object in accordance with certain embodiments of this disclosure;

FIG. 3 illustrates a block diagram of a system that can provide for additional features or aspects of the rewriter component or other components detailed herein in accordance with certain embodiments of this disclosure;

FIG. 4 illustrates a graphical depiction of an example user interface that can be presented on the display in accordance with certain embodiments of this disclosure;

FIG. 5 illustrates a block diagram of a Backend query system that can facilitate translation of a natural language query to a structured language query in accordance with certain embodiments of this disclosure;

FIG. 6 illustrates a block diagram of a system that can provide for additional details or aspects in connection with facilitating translation of a NLQ to a SLQ in accordance with certain embodiments of this disclosure;

FIG. 7 illustrates an example methodology that can provide for translating a natural language query to a structured language query in accordance with certain embodiments of this disclosure;

FIG. 8 illustrates an example methodology that can provide for various ways for determining the confidence score in accordance with certain embodiments of this disclosure;

FIG. 9 illustrates an example methodology that can provide for additional features or aspects in connection with transforming a natural language query to a structured language query in accordance with certain embodiments of this disclosure;

FIG. 10 illustrates an example schematic block diagram for a computing environment in accordance with certain embodiments of this disclosure; and

FIG. 11 illustrates an example block diagram of a computer operable to execute certain embodiments of this disclosure.

### DETAILED DESCRIPTION

### Overview

Many difficulties confront non-technical or casual users that want to retrieve information from conventional large-scale relational databases. For example, discovery is one difficulty because previous database systems typically require a user to know which table (or other portion of the database) is the right table to answer the query. Syntax can be another difficulty as previous database systems typically require a user to formulate the query in proper structured query language (SQL) or another structured language, which is often beyond the competence level for non-technical or casual users. Additionally or alternatively, semantics can be another difficulty, as even a syntactically correct query might not result in retrieving the desired data, but rather other data that is not desired. A user generally knows what data is desired, but often does not know where that data resides (e.g., discovery) in the database or how to access it (e.g., with proper syntax and semantics).

Since the user knows the data that is desired, just not how to access that data, it can be advantageous if the user can query the database with a natural language (e.g., commonly spoken or written language) query that follows rules with which the user is natively familiar instead of rules of a structured language (typically required by the database) that non-technical or casual users are generally unfamiliar. The disclosed subject matter generally relates to converting a natural language query (NLQ) into a structured language query (SLQ) such as SQL or another structured language that is formatted according to the constraints of an associated database. The disclosed subject matter can interpret the natural language query and provide the necessary translation by, e.g., performing the requisite discovery (e.g., identifying the correct tables, columns, or other portions of the database the query should be directed), and translating to the correct syntax expected by the database and the correct semantics to retrieve the desired data.

Consider a simple example in the context of a query that queries data from a large-scale relational database associated with a content hosting service, which will be used as an example for the remainder of this specification. Suppose the user submits a natural language query that states: “How many views did Gangnam Style get on Android devices in the United States in 2012?” Although the question is apparently simple, non-technical or casual users of relational databases will often struggle to form a SLQ that is capable of answering that question. Typical points of confusion might be included in the following:

(1) Which table of the database has the right data combination that includes devices (in this case “Android”), videos (in this case “Gangnam Style”), country (in this case “United States”), and date range (in this case “November 2012”)?

(2) The database might include multiple tables with the requisite data, so which one is the most efficient (e.g., highest level of aggregation)?

(3) Which column should be used to capture Android devices and how?Should the column device_interface or the column device_os be targeted? Should the term be in all-caps (e.g., ANDROID), initial capitalization (e.g., Android), or lower case (e.g., android)?

(4) How does one filter by country using the column country_code? Is the correct syntax “US,” “USA,” or “United States”?

(5) How does one convert fields like date_id and date_usec into simple date ranges (e.g., November 2012)?

It is observed that similar issues are often present in the case of search engine technology in which an interface to a search engine typically receives natural language input. Generally, a search query rewriter and index are able to come to the correct answer for the many potential variations. However, issues remain as to how to bring such simplicity and convenience to data warehouse queries such as queries to a large-scale relational database.

The disclosed subject matter can resolve these issues and can provide numerous advantages over other systems. In some embodiments, the disclosed subject matter can leverage search engine technology, which can be employed to provide a richer semantic understand of the natural language query. Such technology can also be leveraged to provide additional features such as a spell checker, a stemming agent, addressing plurals variation, identifying n-grams, and so on. With this richer understanding of the semantics of the NLQ, the NLQ can be translated to an intermediate semantic query.

In some embodiments, the disclosed subject matter can provide a dimensional model over the relational database. This dimensional model can include restrictions and assumptions about how the dimensions of the fact tables can be joined (e.g., a one-to-one join, a one-to-many join, etc.). By applying these restrictions on the data model, the intermediate semantic query can be translated to the SLQ much more accurately. For example, for a query that includes “Android views in 2012,” it can be readily determined that “2012” translates to a filter on a date dimension, whereas “views” can translate to a GROUPBY and the summation. By applying a semantic layer over the database that conforms to the dimensional model, the NLQ can be translated to an SLQ much more accurately consisting of complex joins and filters.

In some embodiments, an index of the data in the database can be constructed. The index can be constructed according to search engine techniques in which the data itself is utilized in building the index. The index can therefore be very large and might span multiple machines. The index can include actual data (e.g., values in the relational database) as well as metadata (e.g., column names, table names). Thus, a user is, inter alia, freed of the restraint of exactly naming a particular table or column. For example, the user is not required to state a syntactically correct version of “views by operating system=Android by year=2012” but can instead merely input “Android 2012”, which is typically how the user will construct the query in natural language input. Such can be accomplished because the data elements in the database “2012” and “Android” can be extracted to the index.

In addition, the context of such data elements can be included in the index as well. For instance, “2012” might appear in the database in many different contexts, but based on the fact that number “2012” appears much more often in the context of a date range than, e.g., a number of views or products sold, etc. Thus, a high confidence can be assigned to “2012” appearing in a query to imply the query intends to reference a date range as opposed to something else. Hence, ranking algorithms that are in some ways similar to those utilized by search engine technology can be employed to identify the data elements that a NLQ might be referring to based on confidence scores. For example, if an NLQ is determined to reference five different tables in the database, then the confidence scores can be employed to select the most likely table. Once the most likely table (or column or other portion of the database) is identified, then a semantically correct SLQ can be determined that references the most highly ranked table or set of most highly ranked tables.

In summary, the disclosed subject matter can provide at least three enhancements over prior systems. First, leveraging search technology to gain a better understanding of the NLQ and to provide a translation of the NLQ to an intermediate semantic query. Second, applying the understanding of a data model at a deeper level using dimensional model and semantic model techniques to better translate the semantic query into the SLQ. Third, applying ranking to determine confidence scores associated with the potential data elements to select the most likely data elements and/or SLQ from among the potential data elements or SLQs. Such can provide numerous advantages. For example, large-scale relational database data warehouses can be effectively queried without assistance by non-technical or casual users. Furthermore, the techniques described herein can be applicable to substantially any data warehouse, regardless of the specific implementation.

### Example Frontend Systems that Translate a Natural Lauguage Query to a Structured Language Query

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

It is to be appreciated that in accordance with one or more implementations described in this disclosure, users can consent to providing data in connection with data gathering aspects. In instances where a user consents to the use of such data, the data may be used in an authorized manner. Moreover, one or more implementations described herein can provide for anonymization of identifiers (e.g., for devices or for data collected, received, or transmitted) as well as transparency and user controls that can include functionality to enable users to modify or delete data relating to the user's use of a product or service.

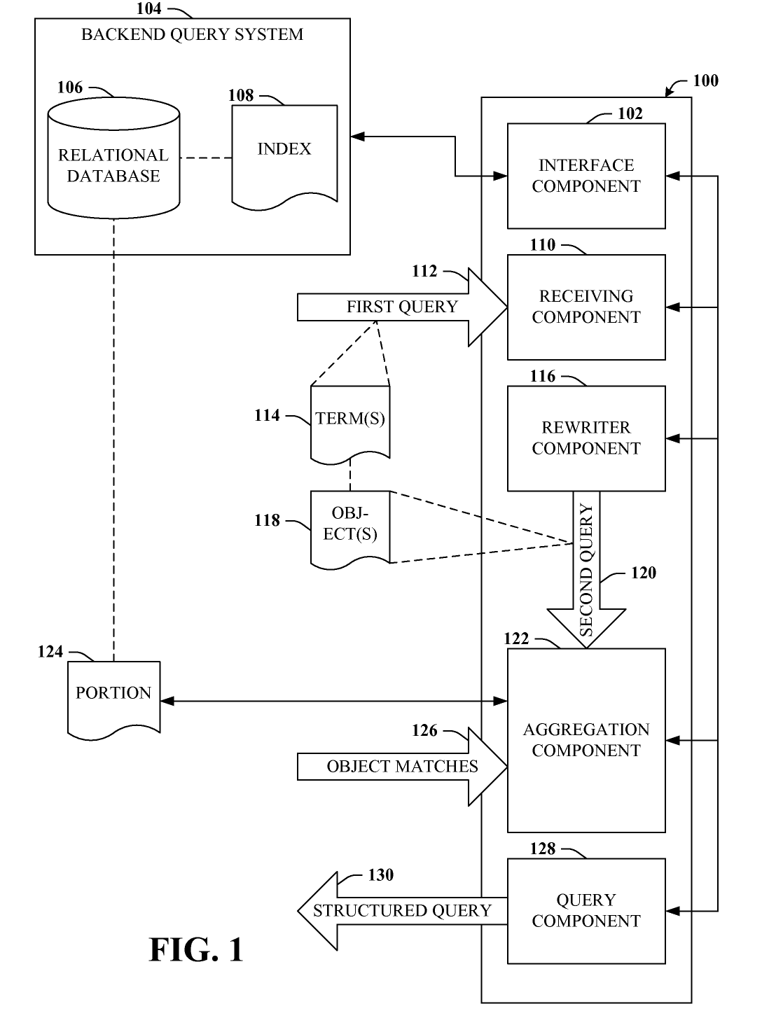

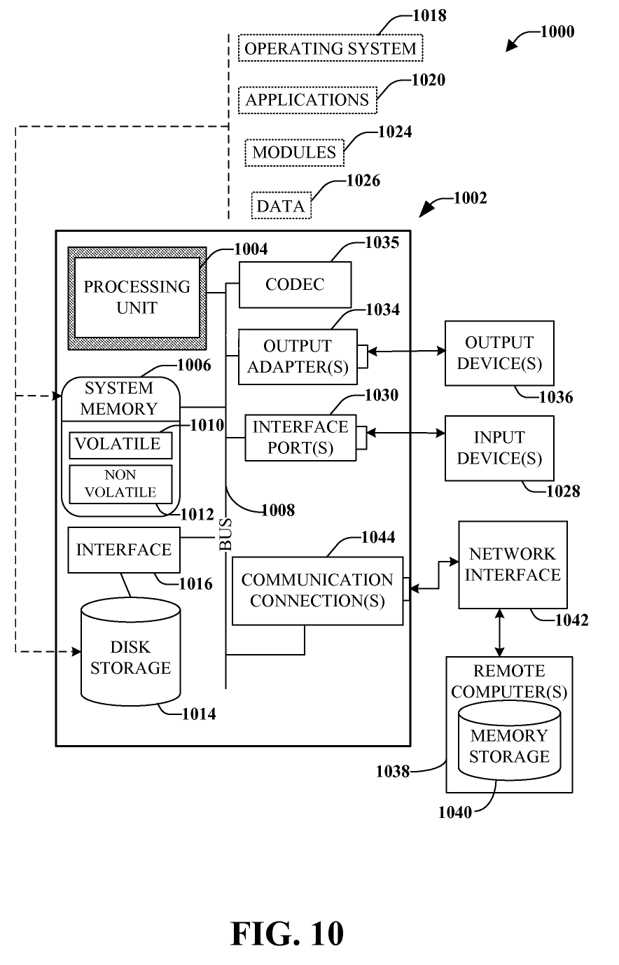

Referring now to FIG. 1, a system 100 is depicted. System 100 can provide, inter alia, for translating a natural language query (NLQ) to a structured language query (SLQ) suitable for use with a relational database. System 100 can include a memory that stores computer executable components and a processor that executes computer executable components stored in the memory, examples of which can be found with reference to FIG. 10. It is to be appreciated that the computer 1002 can be used in connection with implementing one or more of the systems or components shown and described in connection with FIG. 1 and other figures disclosed herein. As depicted, system 100 can include an interface component 102, receiving component 110, a rewriter component 116, an aggregation component 122, and a query component 128.

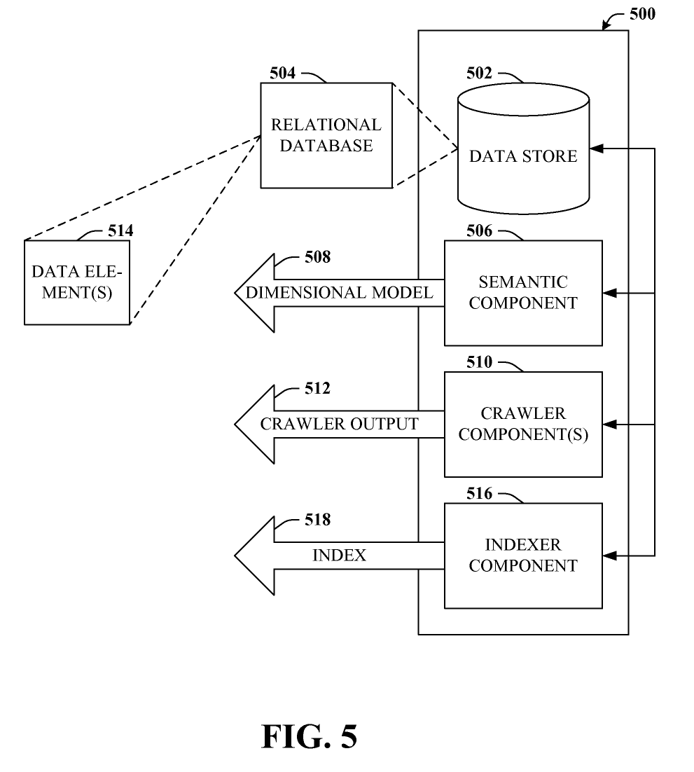

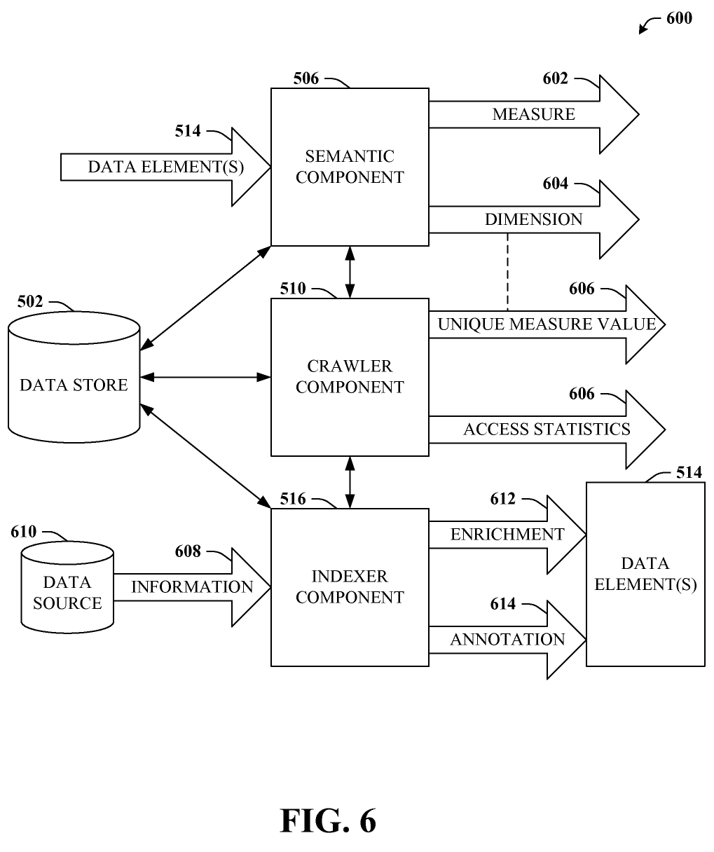

Interface component 102 can be configured to interface to backend query system 104, one embodiment of which is provided in more detail in connection with backend query system 500 of FIG. 5. Backend query system 104 can include data organized as relational database 106 that is accessed according to a defined structured language query such as SQL or the like. Backend system 104 can include index 108 that can represent a consolidated search index of the relational database 106. In some embodiments, index 108 can include data (e.g., all unique values of relational database 106) and metadata (e.g., column names, column descriptions, table names, popularity of data etc.) associated with relational database 106, which is further detailed in connection with FIGS. 5 and 6. Hence, it is understood that index 108, which can be distinct from common database indexes that typically only indexes certain columns and exists as an internal structure of the associated database. As illustrated, data associated with index 108 can reside apart from relational database 106.

Receiving component 110 can be configured to receive natural language query data representing first query 112 with a set of terms 114 constructed according to a natural language. Thus, first query 112 can be a raw query structured according to a natural language. As used herein, a “natural language” can refer to a language typically used by individuals to communicate, such as English, French, Spanish, Japanese, etc. and can include various dialects and slang as well as formal components.

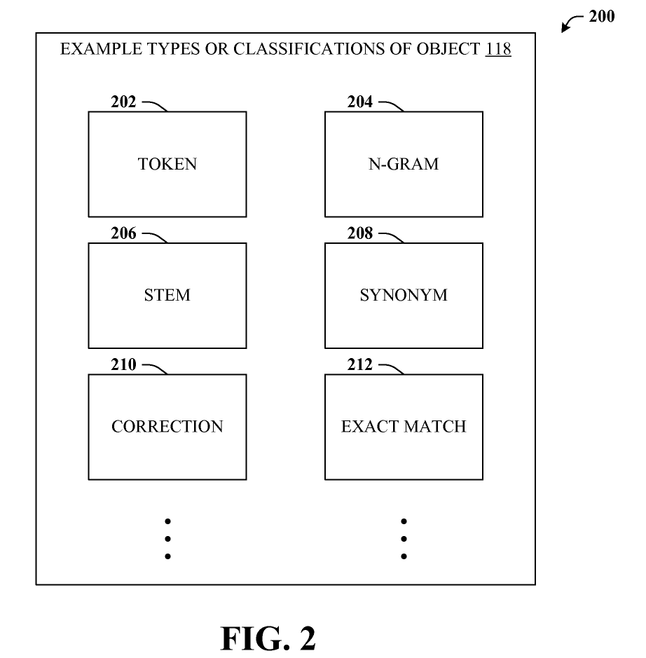

Rewritter component 116 can be configured to parse first query 112 during which term(s) 114 can be classified, respectively, as object(s) 118 based on a comparison of the term with objects 118 of a set of objects included in index 108. Put another way, and returning to the example query of “How many views did Gangnam Style get on Android devices in the United States in 2012?” the various terms of first query 112 can be associated with the same or similar terms (denoted in this context as objects 118) that appear in index 108 and/or relational database 106. For instance, the term “2012” (e.g., term 114) can be associated with one or more instances of “2012” (e.g., object 118) of index 108. As noted, “2012” might appear in relational database 106 and/or index 108 in various contexts. Thus, term “2012” might be associated with multiple analogous objects 118, such as one object 118 with the value “2012” for a date range, and another for a certain count or other numeric value. In addition, various other operations can be performed in connection with mapping terms 114 to objects 118, which is further detailed in connection with FIG. 2.

While still referring to FIG. 1, but turning now as well to FIG. 2, illustration 200 is provided. Illustration 200 depicts numerous examples relating to types or classifications of the object 118. For example, object 118 can be a token 202, e.g., representing a unique or other string in a specific context. As another example, object 118 might be an n-gram 204, where n can be substantially any positive integer, and n-gram 204 represents a number, n, of words that are related akin to compound words. For example, the terms 114 from first query 112 “Gangan” and “Style” or “United” and “States” might imply something very different when those words considered individually or together. For instance, searching a database for two different terms, “united” and “states” might yield very different results from a search that recognizes “united states” can be treated as a bi-gram (e.g., n-gram 204) that has a specific meaning or context when those words are together or in a certain order.

In another example, object 118 can be a stem 206 of an analogous term 114. Stem 206 enable a particular object 118 to represent a given term 114 included in first query 112 in a variety of forms, any of which can be derived from a root word relating to term 114. For instance, the words “being” and “been” can be derived from the root word “be.” Likewise, the words “laughter,” “laughing,” and “laughed” can be derived from the word “laugh,” and therefore any or all of such terms 114 can be associated with a stem 206 (e.g., “laugh”) exemplified by object 118. Object 118 might also be a synonym 208. Thus, a given object 118 with a value of “laugh” might be associated with any or all of the following terms 114: laughter, laughing, laughed, comic, comedy, humor, humorous, and so forth.

Object 118 can also relate to a correction 210 associated with first query 112. Correction 210 might be a spelling correction for a given term 114, a grammar correction for first query 112, or another type of correction. As previously introduced, object 118 might also be exact match 212 for a given term 114 included in first query 112.

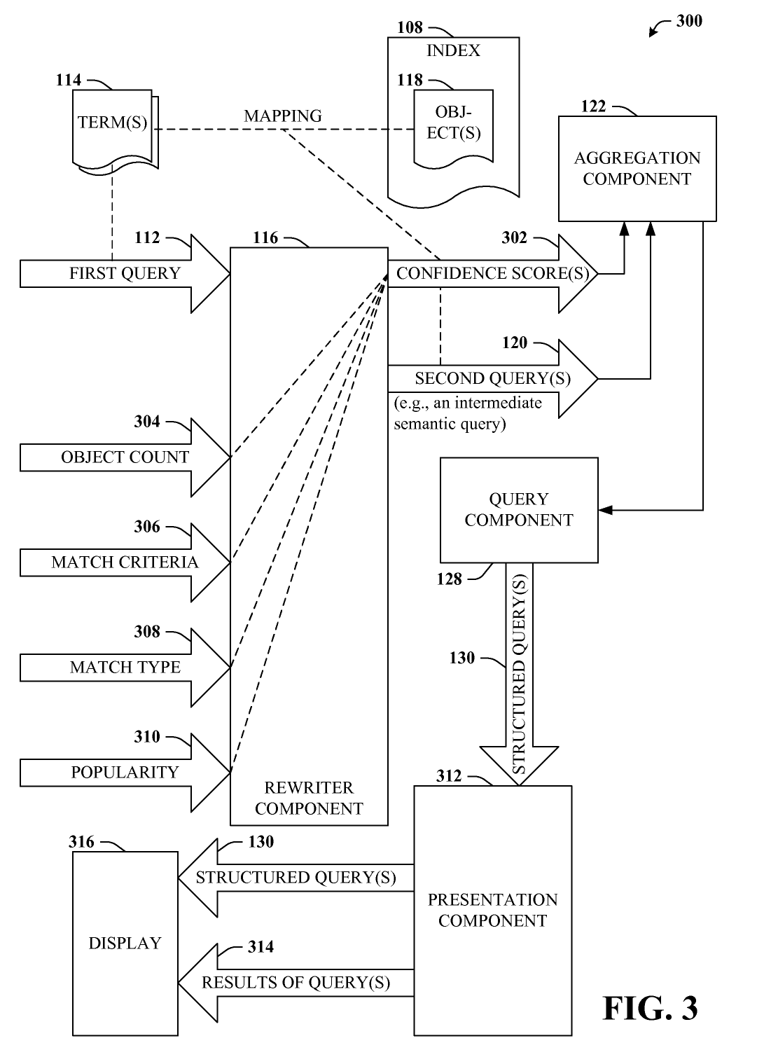

Continuing the discussion of FIG. 1, rewriter component 110 can parse and map terms 114 from a raw, natural language query (e.g., first query 112) to associated objects 118 that exist in index 108 and/or relational database 106. Such can be in consideration of tokens 202, n-grams 204, stems 206, synonyms 208, correction 210, exact match 212, and so on. Such can be accomplished by leveraging search engine technology that is in a mature stage of evolution to address some of these considerations. In addition, rewriter component 110 can rewrite first query 112 (e.g., the natural language query) as a parsed, second query 120 that can represent an intermediate semantic query derived from the natural language query. Second query 120 can include one or more objects 118 that were determined to map to one or more terms 114. In some embodiments, when mapping a term 114 to an object 118, such can be based on a confidence score for a match between the term 114 and the object 118. For example, if rewriter component 116 identifies multiple objects 118 that match term 114, then rewriter component 116 can select from among the multiple objects 118 a specific object 118 with a best confidence score. Additional detail in connection with confidences scores and rewriter component 116 can be found in connection with FIG. 3.

Aggregation component 122 can be configured to identify portion 124 of relational database 106 to reference in connection with second query 120 based on an aggregation of object matches 126 included in portion 122. Portion 124 can be, e.g., a particular table or other addressable segment of relational database 106. Hence, for example, various objects 118 of second query 120 might appear in several different tables, but only a single table might include all relevant objects 118 in second query 120. In that case, the table with all relevant objects 118 can be selected over other tables. As another example, suppose object 118 appears in three different tables with three different columns. In that case, second query 120 might be translated many different ways. However, confidence scores can be employed to select the table that is determined to be most likely to yield the desired results, as is further described with reference to FIG. 3.

Query component 128 can be configured to transform second query 120 to structured language query 130 that is in accord with the defined structured language associated with relational database 106. Query component 128 can transform second query 120 to structured language query 130 based on portion 124 (e.g., based on the table determined most likely to include the data desired).

Turning now to FIG. 3, system 300 is provided. System 300 can provide for additional features or aspects of the rewriter component 116 or other components detailed herein. For example, in some embodiments rewriter component 116 can determine various confidence scores 302 in order to effectuate the mapping of terms 114 to objects 118, or more broadly to effectuate a translation of first query 112 (e.g., a NLQ) to second query 120 (e.g., an intermediate semantic query).

In some embodiments, confidence score 302 can be determined based on object count 304. Object count 304 can be data representing a count of a number of times an associated object 118 appears in index 108 and/or relational database 106. For example, if object 118 with a value of “2012” appears many times in the context of a date range, but only a few times other contexts, then the count for each context can be reflected by an associated confidence score 302. In some embodiments, confidence score 302 can be determined based on match criteria 306. Match criteria 306 can data representing a determination of whether object 118 is an exact match of an associated term 114, a synonym of the associated term 114, a stem of the associated term 114, a full match n-gram of associated terms 114, and so on. For example, all else being equal, an exact match between object 114 and term 112 might result in a higher confidence score 302 than a synonym match.

In some embodiments, confidence score 302 can be determined based on match type 308. Match type 308 can be data representing a determination of whether object 118 is identified as a “dimension” of relational database 106 or a “measure” of relational database 106. Additional detail in connection to measures and dimensions is provided in connection with FIGS. 5 and 6. In some embodiments, confidence score 302 can be determined based on popularity 310. Popularity 310 can be data representing a determination of a popularity associated with a particular portion (e.g., portion 124) of relational database 106. For instance, portion 124 might be a certain table within relational database 106, a column of the table or of relational database 106 in which object 118 appears, a model associated with relational database 106, a view of relational database 106, an attribute of the table, model, or view, and so on.

Upon constructing associated confidence scores 302, various terms of the natural language first query 112 can be mapped to associated objects 118 included in index 108 based on associated confidence scores 302. Such objects 118 can be employed by rewriter component 116 to construct the intermediate, semantic second query 120 or multiple second queries 120 with sufficiently high confidence scores. These data can be provided to aggregation component 122 that can identify the suitable tables (or other portions) of relational database 106 that ought to ultimately be queried in order to correctly satisfy the initial NLQ. Query component 128 can then formulate one or more structured language queries 130 by translating the one or more second queries 120 based on confidence scores 302 or other suitable data.

In some embodiments, system 300 (as well as system 100 of FIG. 1) can also include a presentation component, denoted here as presentation component 312. Presentation component 312 can be configured to present the one or more structured language queries 120 that are ultimately derived from NLQ first query 112. In some embodiments, presentation component 312 can receive results of the one or more structured language queries 130 from the backend query system 104 and present those results 314 as well. For example, if many queries 130 are constructed and presented, then results 314 of a query 130 that is selected (e.g., by the user) can be presented. As another example, results 314 of a query 130 that is related to a best confidence score might be presented. As another example, results 314 of a query 130 might not be automatically presented (and therefore necessitate selection) unless an associated confidence score 302 is sufficiently high. It is understood that structured language query 130 and/or results 314 can be presented to a display 316 or other interface associated with frontend query system 100.

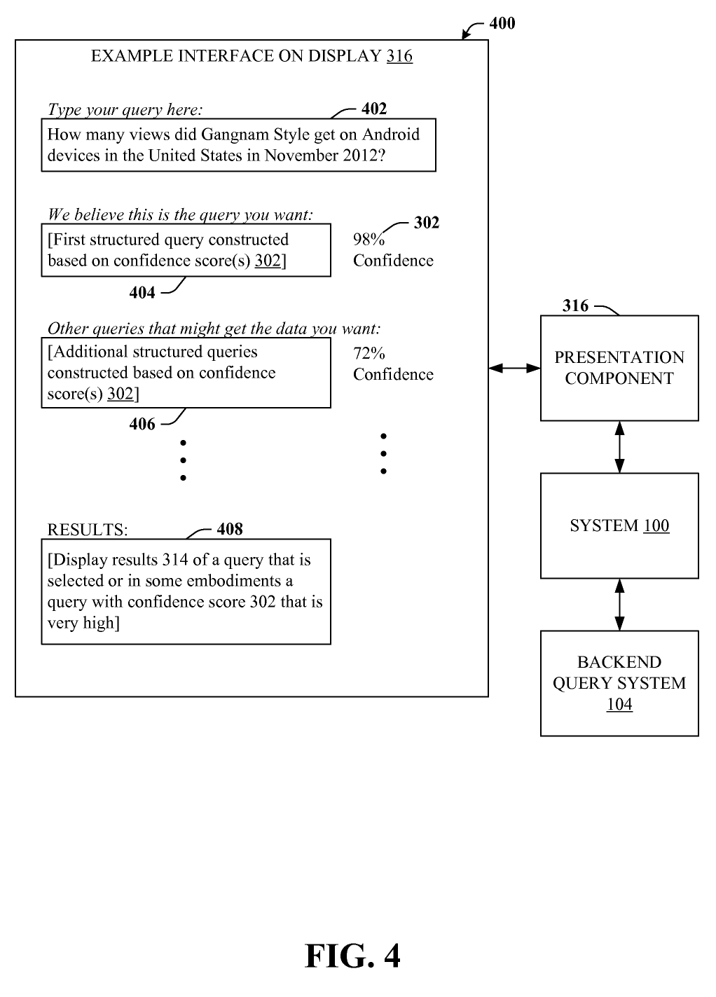

With reference now to FIG. 4, an example user interface 400 is depicted. Example user interface 400 illustrates an example interface that can be presented on the display 316. Interface 400 can receive input from a user as well as provide relevant output. For instance, interface 400 can include NLQ input 402 that represents the natural language query (e.g., first query 112) that might be input by a user. In addition, interface 400 can include various output regions such as SLQ output 404 that represents a syntactically and (within a degree of confidence) a semantically correct translation of the natural language query to the structured language query. As depicted associated confidence scores 302 can be presented as well. In some embodiments (e.g., if confidence scores 302 are not sufficiently high or if multiple associated confidence scores have similar cardinality, then multiple SLQs might be presented, with additional SLQs denoted by reference numeral 406.

Interface 400 can also include a results section 408 that presents results to one or more structured language queries. Such results can be received in response to submitting an associated structured language query to backend query system 104. Results can be presented in response to selection input (e.g., a user selecting the SLQ in section 404 or 406). In some embodiments, results 408 might be presented automatically, e.g., in the case in which confidence score 302 for SLQ 130 is sufficiently high.

### Example Backend Systems That Can Facilitate Translation of a Natural Lauguage Query to a Structured Language Query

Turning now to FIG. 5, backend query system 500 is depicted. Backend query system 500 relates to a backend query system that can facilitate translation of a natural language query to a structured language query. System 500 can be substantially similar to backend query system 104 detailed in connection with FIG. 1. Backend query system can include data store 502, semantic component 506, crawler component(s) 510, and indexer component 516. In some embodiments, data store 502 can be remote from and communicatively coupled to system 500. As used herein, data store 502 is intended to be a repository of all or portions of data, data sets, or information described herein or otherwise suitable for use with the described subject matter. Data store 502 can be centralized, either remotely or locally cached, or distributed, potentially across multiple devices and/or schemas. Furthermore, data store 502 can be embodied as substantially any type of memory, including but not limited to volatile or non-volatile, sequential access, structured access, or random access and so on. It should be understood that all or portions of data store 502 can be included in systems 500, or can reside in part or entirely remotely from system 500. Data store 502 can be configured to store data organized as relational database 504 that is accessed according to a defined structured language (e.g., SQL).

Semantic component 506 can be configured to construct dimensional model 508 for relational database 504. Dimensional model 508 can represent a semantic layer over relational database 504. Dimensional model 508 can be employed to, e.g., enable accurate translation of very complex queries (e.g., in terms of joins, filters, aggregations, etc.) based on the inherent constraints of the associated SLQ even though such constraints might not exist for the associated NLQ and/or might be beyond the competence of the user.

Crawler component 510 include one or more crawler mechanisms and can be configured to examine data elements 514 of relational database 504 and/or data store 502 and can provide crawler output 512. Crawler output 512 can be data that represents an extraction of a data elements 514 based on dimensional model 508.

Indexer component 516 can be configured to construct index 518 for relational database 504 and/or data store 502 that can be substantially similar to index 108 of FIG. 1. Index 518 can be constructed based on dimensional model 508 and crawler output 512. Additional detail associated with semantic component 506, crawler component 510, and indexer component 516 can be found with reference to FIG. 6.

Referring to FIG. 6, system 600 is provided. System 600 can provide for additional details or aspects in connection with facilitating translation of a NLQ to a SLQ. System 600 can include all or a portion of components detailed in connection with FIG. 5 or other suitable components detailed herein. As previously described, semantic component 506 can construct dimensional model 508 that represents a semantic layer over the relational database 504. In some embodiments, semantic component can classify, in the dimensional model 508, a particular data element 514 as a measure 602 or a dimension 604. As used herein, measure 602 can represent a value that supports aggregation (e.g., an amount of money, a number of views, etc.). On the other hand, as used herein, dimensions 604 can represent a unit by which a measure 602 is aggregated (e.g., dollars or other currency unit, month, year or another unit of time, etc.). Other classifications apart from measures 602 and dimensions 604 are possible, including classifications that represent a combination of the two.

As discussed, crawler component 510 can extract data elements 514 from data store 502 based on dimensional model 508 constructed by semantic component 506. In some embodiments, crawler component 510 can be configured to specifically extract unique measure values 606. Such can relate to measures 602 that have values that are unique for a given dimension 604. Crawler 510 might also record a number of times a particular measure 602 value occurs for a particular dimension 604. In some embodiments, crawler component 510 can be configured to extract access statistics associated with the data store 502. Such might be employed to determine a popularity of a given portion 122 of relational database 104 or the like.

As discussed, indexer component 516 can construct index 518 for data store 502 based on dimensional model 508 and crawler output 512. In addition, in some embodiments, indexer component 516 can be configured to receive information 608 from a data source 610. Information 608 can be employed to enrich a data element as illustrated by reference numeral 612. Enrichment 612 can be recorded in data store 502 or index 518. Data source 610 can be remote from and/or distinct from data store 502. By way of illustration, data element 514 might be enriched based on video ids drawn from video corpus data sources or by dates using known calendar terms from an associated data source 610.

In some embodiments, indexer component 516 can be configured to add a ranking annotation to data element 514, denoted by reference numeral 614. Such annotations 614 can be applied to data elements 514 included in relational database 504 or in indexed versions included in index 518. Annotations 614 can be ranking annotations and can be based on default weights of an extracted word or phrase, common n-grams, stopwords used, or other similar examples, such as those detailed in connection with FIG. 2.

### Example Methods for Translating a Natural Language Query to a Structured Language Query

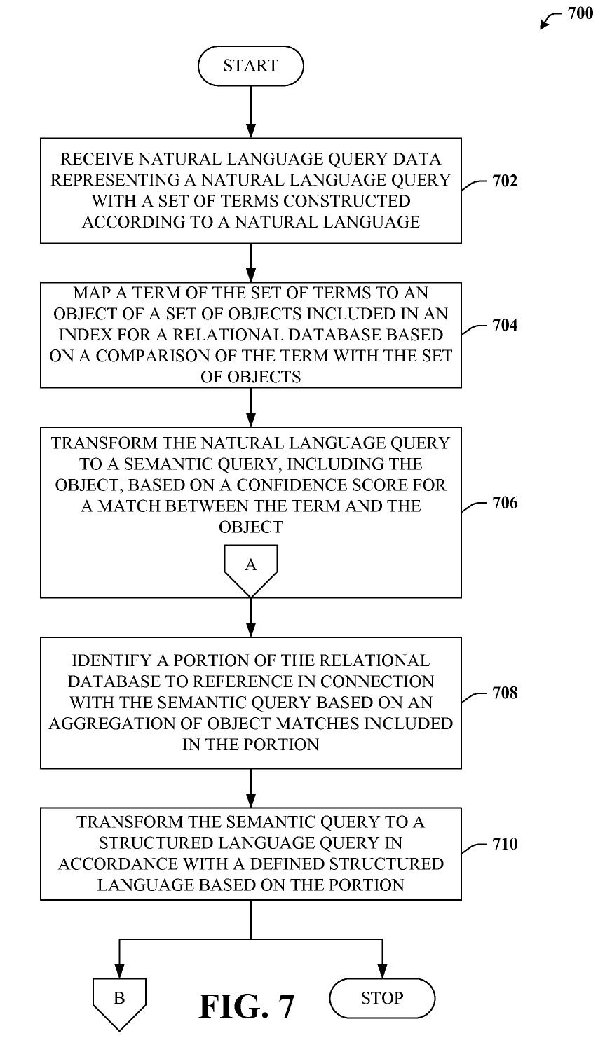

FIGS. 7-9 illustrate various methodologies in accordance with certain embodiments of this disclosure. While, for purposes of simplicity of explanation, the methodologies are shown and described as a series of acts within the context of various flowcharts, it is to be understood and appreciated that embodiments of the disclosure are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers. The term article of manufacture, as used herein, is intended to encompass a computer program accessible from any computer-readable device or storage media.

FIG. 7 illustrates exemplary method 700. Method 700 can provide for translating a natural language query to a structured language query. For example, at reference numeral 702, natural language query data can be received (e.g., by a receiving component), for instance, via input of the natural language query to a query system interface. The natural language query data can be representative of a natural language query with a set of terms constructed according to a natural language, e.g., a natively written language.

At reference numeral 704, a term of a set of terms constituting the NLQ can be mapped (e.g., by a rewriter component) to an object of a set of objects included in an index for a relational database. Such mapping of the term to the object can be based on a comparison of the term with the set of objects.

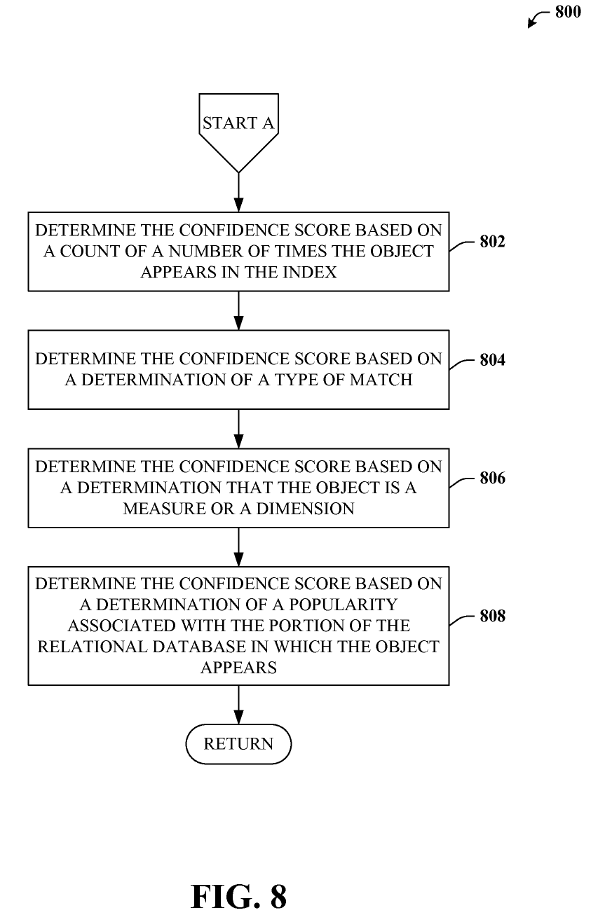

At reference numeral 706, the natural language query can be transformed to a semantic query (e.g., by the rewriter component). The semantic query can include one or more of the objects mapped to terms at reference numeral 704. The transforming to the semantic query can be based on a confidence score for a match between the term and the object. Various embodiments associated with determining the confidence score are further detailed via insert A, which can be found at FIG. 8.

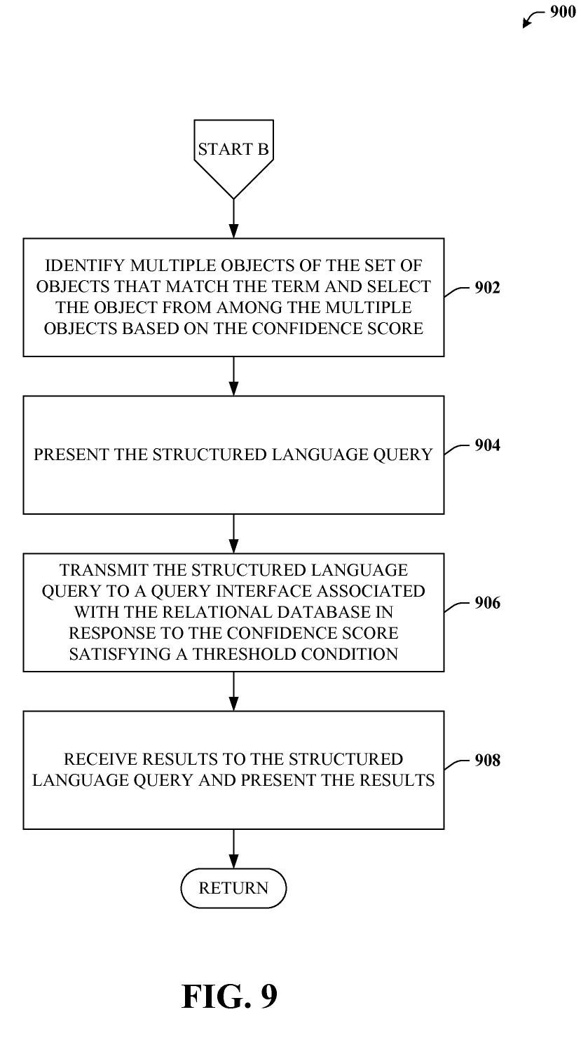

At reference numeral 708, a portion (e.g., a particular table or column) can of the relational database to be referenced in connection with the semantic query can be identified (e.g., by an aggregation component). Such identification of the portion can be based on an aggregation of object matches included in the portion. Method 700 can proceed to insert B, which is detailed at FIG. 9, or can stop.

FIG. 8 illustrates exemplary method 800. Method 800 can provide for various ways for determining the confidence score that is leveraged at reference numeral 706 of FIG. 7. For example, at reference numeral 802, the confidence score can be determined based on a count of a number of times the object appears in the index. It is appreciated that a single term from the NLQ might be mapped to multiple related objects of the index, such as mapped to multiple objects that reflect a different context of the term. In such cases, the number of times the object appears in one context can influence the confidence score for that object.

At reference numeral 804, the confidence score can be determined based on a determination of a type of match. For example, the confidence score can be influenced based on whether the object is an exact match of the term, a synonym of the term, a stem variation of the term, a full match n-gram of n terms, a partial match of one or more terms, or the like.

At reference numeral 806, the confidence score can be determined based on a determination that the object is a measure, a dimension and so on. For example, an object that is an exact match of a measure can be weighted most significantly in terms of the confidence score. Next most significant might be an exact match of a dimension value followed by an exact match of a dimension name, and so on. Likewise, a synonym for a measure might carry a slightly lower confidence score followed by a synonym for a dimension value, and then by a synonym for a dimension name. Similarly, stemming variation matches and correction-based matches might also carry ordered weights for confidence scores in a like manner.

At reference numeral 808, the confidence score can be determined based on a determination of a popularity associated with the portion of the relational database in which the object appears. For example, if a particular table or another portion of the relational database has seen many accesses in the recent past then such can be an indication that the data for that portion is likely to be relevant to any given query since that data has been relevant for many other queries. Such can be reflected in the confidence score as well.

Turning now to FIG. 9, exemplary method 900 is depicted. Method 900 can provide for additional features or aspects in connection with transforming a natural language query to a structured language query. At reference numeral 902, multiple objects of the set of objects that match the term can be identified. In addition, one object can be selected from among the multiple objects based on the confidence score.

At reference numeral 904, the structured language query can be presented (e.g., by a presentation component). The structured language query (or multiple competing structured language queries) can be presented to the same display or user interface in which the natural language query was input. Advantageously, a user can review the presentation to determine if the structured language query is likely to yield the desired results. Such an analysis typically requires a much lesser degree of competence or understanding than building the correct structured language query from scratch.

At reference numeral 906 the structured language query can be transmitted (e.g., by an interface component) to a query interface associated with the relational database. In some embodiments, such can be in response to the confidence score satisfying a threshold condition (e.g., the confidence score is greater than 95% or the like). In other embodiments, the structured language query can be transmitted in response to selection by the user (e.g., selecting from among several SLQs that are presented that are determined to be likely to satisfy the NLQ).

At reference numeral 908, results to the structured language query can be received from the backend query system. Such results can be presented to the display and/or user interface.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

With reference to FIG. 10, a suitable environment 1000 for implementing various aspects of the claimed subject matter includes a computer 1002. The computer 1002 includes a processing unit 1004, a system memory 1006, a codec 1035, and a system bus 1008. The system bus 1008 couples system components including, but not limited to, the system memory 1006 to the processing unit 1004. The processing unit 1004 can be any of various available processors. Dual microprocessors and other multiprocessor architectures also can be employed as the processing unit 1004.

The system bus 1008 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI) or others now in existence or later developed.

The system memory 1006 includes volatile memory 1010 and non-volatile memory 1012. The basic input/output system (BIOS), containing the basic routines to transfer information between elements within the computer 1002, such as during start-up, is stored in non-volatile memory 1012. In addition, according to present innovations, codec 1035 may include at least one of an encoder or decoder, wherein the at least one of an encoder or decoder may consist of hardware, software, or a combination of hardware and software. Although, codec 1035 is depicted as a separate component, codec 1035 may be contained within non-volatile memory 1012 or included in other components detailed herein. By way of illustration, and not limitation, non-volatile memory 1012 can include read only memory (ROM), programmable ROM (PROM), electrically programmable ROM (EPROM), electrically erasable programmable ROM (EEPROM), or flash memory. Volatile memory 1010 includes random access memory (RAM), which acts as external cache memory. According to present aspects, the volatile memory may store the write operation retry logic (not shown in FIG. 10) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM), resistive RAM (RRAM), or others now in existence or later developed.

Computer 1002 may also include removable/non-removable, volatile/non-volatile computer storage medium. FIG. 10 illustrates, for example, disk storage 1014. Disk storage 1014 includes, but is not limited to, devices like a magnetic disk drive, solid state disk (SSD) floppy disk drive, tape drive, flash memory card, or memory stick. In addition, disk storage 1014 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1014 to the system bus 1008, a removable or non-removable interface is typically used, such as interface 1016. It is appreciated that storage devices 1014 can store information related to a user. Such information might be stored at or provided to a server or to an application running on a user device. In one embodiment, the user can be notified (e.g., by way of output device(s) 1036) of the types of information that are stored to disk storage 1014 and/or transmitted to the server or application. The user can be provided the opportunity to opt-in or opt-out of having such information collected and/or shared with the server or application (e.g., by way of input from input device(s) 1028).

It is to be appreciated that FIG. 10 describes software that acts as an intermediary between users and the basic computer resources described in the suitable operating environment 1000. Such software includes an operating system 1018. Operating system 1018, which can be stored on disk storage 1014, acts to control and allocate resources of the computer system 1002. Applications 1020 take advantage of the management of resources by operating system 1018 through program modules 1024, and program data 1026, such as the boot/shutdown transaction table and the like, stored either in system memory 1006 or on disk storage 1014. It is to be appreciated that the claimed subject matter can be implemented with various operating systems or combinations of operating systems.

A user enters commands or information into the computer 1002 through input device(s) 1028. Input devices 1028 include, but are not limited to, a pointing device such as a mouse, stylus, touch pad, keyboard, microphone, joystick, game pad, satellite dish, scanner, TV tuner card, digital camera, digital video camera, web camera, and the like. These and other input devices connect to the processing unit 1004 through the system bus 1008 via interface port(s) 1030. Interface port(s) 1030 include, for example, a serial port, a parallel port, a game port, and a universal serial bus (USB). Output device(s) 1036 use some of the same type of ports as input device(s) 1028. Thus, for example, a USB port may be used to provide input to computer 1002 and to output information from computer 1002 to an output device 1036. Output adapter 1034 is provided to illustrate that there are some output devices 1036 like monitors, speakers, and printers, among other output devices 1036, which require special adapters. The output adapters 1034 include, by way of illustration and not limitation, video and sound cards that provide a means of connection between the output device 1036 and the system bus 1008. It should be noted that other devices and/or systems of devices provide both input and output capabilities such as remote computer(s) 1038.

Computer 1002 can operate in a networked environment using logical connections to one or more remote computers, such as remote computer(s) 1038. The remote computer(s) 1038 can be a personal computer, a server, a router, a network PC, a workstation, a microprocessor based appliance, a peer device, a smart phone, a tablet, or other network node, and typically includes many of the elements described relative to computer 1002. For purposes of brevity, only a memory storage device 1040 is illustrated with remote computer(s) 1038. Remote computer(s) 1038 is logically connected to computer 1002 through a network interface 1042 and then connected via communication connection(s) 1044. Network interface 1042 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1044 refers to the hardware/software employed to connect the network interface 1042 to the bus 1008. While communication connection 1044 is shown for illustrative clarity inside computer 1002, it can also be external to computer 1002. The hardware/software necessary for connection to the network interface 1042 includes, for exemplary purposes only, internal and external technologies such as, modems including regular telephone grade modems, cable modems and DSL modems, ISDN adapters, and wired and wireless Ethernet cards, hubs, and routers.

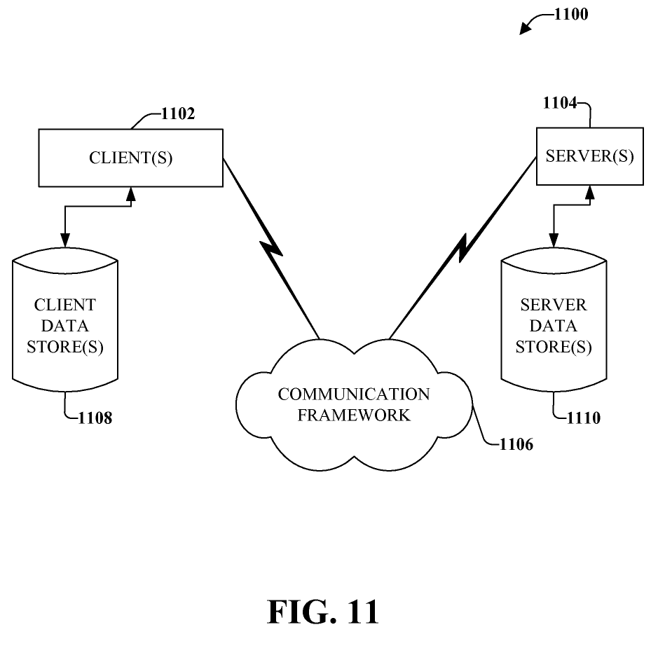

Referring now to FIG. 11, there is illustrated a schematic block diagram of a computing environment 1100 in accordance with this specification. The system 1100 includes one or more client(s) 1102 (e.g., laptops, smart phones, PDAs, media players, computers, portable electronic devices, tablets, and the like). The client(s) 1102 can be hardware and/or software (e.g., threads, processes, computing devices). The system 1100 also includes one or more server(s) 1104. The server(s) 1104 can also be hardware or hardware in combination with software (e.g., threads, processes, computing devices). The servers 1104 can house threads to perform transformations by employing aspects of this disclosure, for example. One possible communication between a client 1102 and a server 1104 can be in the form of a data packet transmitted between two or more computer processes wherein the data packet may include video data. The data packet can include a cookie and/or associated contextual information, for example. The system 1100 includes a communication framework 1106 (e.g., a global communication network such as the Internet, or mobile network(s)) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

In one embodiment, a client 1102 can transfer an encoded file, in accordance with the disclosed subject matter, to server 1104. Server 1104 can store the file, decode the file, or transmit the file to another client 1102. It is to be appreciated, that a client 1102 can also transfer uncompressed file to a server 1104 and server 1104 can compress the file in accordance with the disclosed subject matter. Likewise, server 1104 can encode video information and transmit the information via communication framework 1106 to one or more clients 1102.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

1. A frontend query system, comprising:
a memory that stores computer executable components; and
a microprocessor that executes the following computer executable components stored in the memory:
an interface component that interfaces to a backend query system that includes data organized as a relational database that is accessed according to a defined structured language and an index of the relational database;
a receiving component that receives natural language query data representing a first query with a set of terms constructed according to a natural language;
a rewriter component that parses the first query, classifies terms of the set of terms as objects of a set of objects included in the index of the relational database by comparing each term of the set of terms with objects of the set of objects and using a confidence score for a match between each term and at least one object, and rewrites the first query as a second query by using the one or more objects to which the set of terms of the natural language are classified;
an aggregation component that identifies portions of the relational database wherein each identified portion has at least one match between an object in the portion of the relational database and an object included in the second query, and the aggregation component determines the portion of the relational database with a greatest number of matches between objects in the portion of the relational database and the objects included in the second query among the identified portions of the relational database as a portion of the relational database that has a highest level of aggregation; and
a query component that transforms the second query to a structured language query in accordance with the defined structured language using the portion of the relational database that has the highest level of aggregation.

2. The frontend query system of claim 1, wherein the object of the set of objects is at least one of a token represented by the term, an n-gram represented by the term, a stem of the term, a synonym of the term, a corrected term, or an exact match of the term.

3. The frontend query system of claim 1, wherein the rewriter component identifies multiple objects of the set of objects that match the term and selects the object from among the multiple objects based on the confidence score.

4. The frontend query system of claim 1, wherein the rewriter component determines the confidence score based on at least one of: a count of a number of times the object appears in the index, a determination of whether the object is an exact match of the term, a determination of whether the object is a synonym of the term, a determination of whether the object is a full match of the term, a determination of whether the object is a partial match of the term, a determination of whether the object is identified as a dimension of the relational database, a determination of whether the object is identified as a measure of the relational database, a determination of a popularity associated with a table of the relational database in which the object appears, or a determination of a popularity associated with a column of the relational database in which the object appears.

5. A frontend query system of claim 1, wherein the portion of the relational database is at least one of: a table included in the relational database, a model associated with the relational database, a view of the relational database, a column of the table, model or view, or an attribute of the table, model or view.

6. The frontend query system of claim 1, further comprising a presentation component that presents the structured language query.

7. The frontend query system of claim 6, wherein the presentation component receives results from the backend query system and presents the results.

8. A backend query system, comprising:
a memory that stores computer executable components; and
a microprocessor that executes the following computer executable components stored in the memory:
a data store that stores data organized as a relational database that is accessed according to a defined structured language;
a semantic component that constructs a dimensional model for the relational database, wherein the dimensional model converts an intermediate semantic query of a natural language query to a structured language query using a portion of the relational database with a greatest number of matches between data elements in the portion of the relational database and data elements of the intermediate semantic query among other portions of the relational database, the dimensional model including constraints on how data elements of the data store can be combined and representing a semantic layer over the relational database;
a crawler component that examines data elements of the data store and provides crawler output that represents an extraction of a data element of the data elements based on the dimensional model; and
an indexer component that constructs an index for the data store based on the dimensional model and the crawler output, the index including one or more data elements of the data store that map to one or more terms of the natural language query, wherein the data elements are used to create the intermediate semantic query from the natural language query.

9. The backend query system of claim 8, wherein the semantic component classifies, in the dimensional model, the data element of the relational database as a measure that represents a value that supports aggregation or a dimension that represents a unit by which an associated measure is aggregated.

10. The backend query system of claim 9, wherein the crawler component extracts unique measure values for the dimension.

11. The backend query system of claim 8, wherein the crawler component extracts access statistics associated with the data store.

12. The backend query system of claim 8, wherein the indexer component receives information from a data source and employs the information to enrich the data element in the index.

13. The backend query system of claim 8, wherein the indexer component adds a ranking annotation to the data element.

14. The backend query system of claim 8, wherein the crawler component periodically reexamines the data store and produces updated crawler output, and the indexer component updates the index based on the updated crawler output.

15. A method, comprising:
employing a computer-based processor to execute computer executable components stored in a memory to perform the following:
receiving natural language query data representing a natural language query with a set of terms constructed according to a natural language;
mapping terms of the set of terms to objects of a set of objects included in an index for a relational database by comparing each term with objects in the set of objects and choosing an object to map to the term using a confidence score for a match between the term and the at least one object;
transforming the natural language query to an intermediate semantic query by using the one or more objects mapped to the set of terms of the natural language query;
identifying portions of the relational database, wherein each identified portion has at least one match between an object in the portion of the relational database and an object included in the second query;
determining the portion of the relational database that matches a greatest number of objects of the semantic query from among the identified portions of the relational database as a portion of the relational database that has a highest level of aggregation; and
transforming the semantic query to a structured language query in accordance with a defined structured language using the portion of the relational database that has the highest level of aggregation.

16. The method of claim 15, further comprising determining the confidence score based on at least one of: a count of a number of times the object appears in the index, a determination of whether the object is an exact match of the term, a determination of whether the object is a synonym of the term, a determination of whether the object is a full match of the term, a determination of whether the object is a partial match of the term, a determination of whether the object is identified as a dimension of the relational database, a determination of whether the object is identified as a measure of the relational database, a determination of a popularity associated with a table of the relational database in which the object appears, or a determination of a popularity associated with a column of the relational database in which the object appears.

17. The method of claim 15, further comprising identifying multiple objects of the set of objects that match the term and selecting the object from among the multiple objects based on the confidence score.

18. The method of claim 15, further comprising presenting the structured language query.

19. The method of claim 15, further comprising transmitting the structured language query to a query interface associated with the relational database in response to the confidence score satisfying a threshold condition.

20. The method of claim 15, further comprising receiving results to the structured language query and presenting the results.
